(19) United States
(12) Patent Application Publication
(10) Pub. No.: US 2014/0037397 A1
(43) Pub. Date: Feb. 6, 2014

(54) MANUFACTURING METHOD OF MACHINE TOOL AND MACHINE TOOL

(71) Applicant: Toshiba Kikai Kabushiki Kaisha, Tokyo (JP)

(72) Inventors: Katutoshi TANAKA, Numazu-shi (JP); Norio YAMANISHI, Numazu-shi (JP); Wataru OHSONE, Numazu-shi (JP)

(73) Assignee: Toshiba Kikai Kabushiki Kaisha, Tokyo (JP)

(21) Appl. No.: 13/954,477

(22) Filed: Jul. 30, 2013

(30) Foreign Application Priority Data
Jul. 31, 2012 (JP) 2012-169952

(51) Int. Cl. B23Q 1/70

(52) U.S. Cl. CPC B23Q 1/70
USPC 409/235; 29/428

(57) ABSTRACT

In a manufacturing method of a machine tool including: a table having a workpiece mount face on which a workpiece is placed; a spindle head; and a relative movement mechanism for moving the spindle head relative to the table, the spindle head including: a spindle head body; a spindle rotatably supported by the spindle head body via a bearing mechanism and having a tool at an end thereof; and a rotary drive source for rotating the spindle, a plurality of types of structural members of different shapes being made of a carbon fiber reinforced plastic are prepared in advance and the structural members of the different shapes are combined to provide the spindle head body.

The entire disclosure of Japanese Patent Applications No. 2012-169952 filed Jul. 31, 2012 is expressly incorporated by reference herein.

### BACKGROUND OF THE INVENTION

1. Field of the Invention

The present invention relates to a manufacturing method of a machine tool, and a machine tool manufactured by the method. More specifically, the present invention relates to a manufacturing method of a machine tool provided with a table on which a workpiece is placed, a spindle head, and a relative movement mechanism for moving the spindle head relative to the table, and a machine tool manufactured by the method.

2. Description of Related Art

Recently, speed-up in a movement of a machine tool has been increasingly demanded in order to improve productivity.

To meet the above demand, a part of components (e.g. cross rail) of some of the machine tools are made of carbon fiber reinforced plastics (CFRP) for the purpose of weight reduction and increase in rigidity (see Literature 1: JP-A-2000-263356).

Incidentally, it is requisite for a machine tool that performs fine processing to have a lightweight spindle head. Thus, it may be conceivable to provide a body of the spindle head with a CFRP.

In order to mold a component with a CFRP, various molding methods are known, including: a prepreg method in which a number of intermediate materials (prepregs) prepared by impregnating a plastic material to a tape or a fabric made of unidirectional arrays of carbon fibers are laminated and put in an autoclave (pressurized vessel) and are pressurized and hardened under a high temperature; a hand lay-up method in which an intermediate material such as a prepreg is laid inside a mold and a series of coating, impregnating and defoaming of a molten plastic resin mixed with a hardening agent are repeated to form a component of a predetermined depth; and an RTM method in which a carbon fiber fabric is set inside a mold and a resin (base material) is impregnated thereto and subsequently is hardened.

However, the above molding methods require a complicated molding apparatus and/or much work and time for fabrication, resulting in extremely high production cost.

### SUMMARY OF THE INVENTION

In view of the above, an object of the invention is to provide a manufacturing method of a machine tool that is capable of inexpensively providing a lightweight spindle head, and a machine tool.

A manufacturing method according to an aspect of the invention is for a machine tool including: a table provided with a workpiece mount face on which a workpiece is placed; a spindle head; and a relative movement mechanism for moving the spindle head relative to the table, the spindle head comprising: a spindle head body; a spindle rotatably supported by the spindle head body via a bearing mechanism and being provided with a tool at an end thereof; and a rotary drive source for rotating the spindle, the method including: preparing in advance a plurality of types of structural members of different shapes made of a carbon fiber reinforced plastic; and combining the structural members of the different shapes to provide the spindle head body.

Herein, the carbon fiber reinforced plastic may be any one of a PAN (polyacrylonitrile) fiber prepared by baking a polyacrylonitrile fiber and a pitch fiber prepared by baking pitch obtained as a residue of coal or petroleum refinement after melting and spinning the pitch.

According to the above arrangement, since the plurality of types of structural members of different shapes made by the carbon fiber reinforced plastic are prepared in advance, the spindle head body can be provided by combining and connecting (e.g. bonding with the use of an adhesive or a rivet) the structural members. Thus, since the weight of the spindle head can be reduced with a low cost, the speed-up of the spindle head can be achieved, so that the spindle head can be used for fine processing and the productivity can be enhanced.

In the manufacturing method of a machine tool according to the above aspect, it is preferable that the structural members comprise a face member and a lower face member, the spindle head body is provided in a rectangular tube shape of which at least three faces from among a front face, side faces and back face are surrounded by the face member and of which a lower face is closed by the lower face member, and the spindle is rotatably supported by the lower face member via the bearing mechanism.

According to the above arrangement, since the spindle head body is provided in a rectangular tube shape of which at least three faces from among a front face, side faces and back face are surrounded by the sheet material structural member and of which a lower face is closed by the lower-face material structural member, the spindle head body is less likely to be deformed or distorted. Thus, a high accuracy of the machine tool can be ensured.

In the manufacturing method of a machine tool according to the above aspect of the invention, it is preferable that the structural members comprise a reinforcing face member, and the reinforcing face member is disposed at a vertically middle of the rectangular tube substantially in parallel to the lower face member.

According to the above arrangement, since the reinforcing face material structural member is provided at the middle part in the square tube, the rigidity of the spindle head body can be enhanced by the presence of the reinforcing face material structural member, thereby further restraining the generation of deformations and distortions.

In the manufacturing method of a machine tool according to the above aspect, it is preferable that the structural members comprise at least one of components of a C-shaped cross section, an I-shaped cross section, an L-shaped cross section, an H-shaped cross section, a T-shaped cross section, a rectangular cross section, a triangular cross section and a circular cross section in addition to the face member.

According to the above arrangement, with the combination of the face member and at least one of the components of the C-shaped cross section, the I-shaped cross section, the L-shaped cross section, the H-shaped cross section, the T-shaped cross section, the rectangular cross section, the triangular cross section and the circular cross section, the spindle head body of a desired shape, structure and strength can be easily provided.

In the manufacturing method of a machine tool according to the above aspect, it is preferable that the relative movement mechanism comprises: an X-axis movement mechanism for moving the table in an X-axis direction parallel to the workpiece mount face; a portal column bridging over the table; a saddle provided to a horizontal beam of the portal column in a manner movable in a Y-axis direction parallel to the workpiece mount face of the table and orthogonal to the X-axis direction, the saddle supporting the spindle head; a Y-axis movement mechanism for moving the saddle in the Y-axis direction; and a Z-axis movement mechanism for vertically moving the spindle head relative to the saddle in a Z-axis direction orthogonal to the X-axis direction and the Y-axis direction, and the table and the saddle are provided by combining the structural members of the different shapes.

According to the above arrangement, since the table and the saddle are also provided by the combination of the structural members made of the carbon fiber reinforced plastic, the weight can be reduced while keeping a high strength and high elasticity. Thus, since the speed-up of the entirety of the machine tool can be achieved while keeping a high accuracy, improvement in productivity can be expected.

A machine tool according to another aspect of the invention is manufactured by the manufacturing method of a machine tool according to any one of the above arrangements of the invention.

According to the above arrangement, the same advantages as described above for the manufacturing method can be expected.

### BRIEF DESCRIPTION OF THE DRAWINGS

FIG. 1 is a perspective view showing a machine tool according to an exemplary embodiment of the invention.

FIG. 2 is an illustration of a spindle device and a peripheral part thereof according to the exemplary embodiment.

FIG. 3 is an illustration showing a structure of a table according to the exemplary embodiment.

FIG. 4 is an illustration showing a structure of a saddle according to the exemplary embodiment.

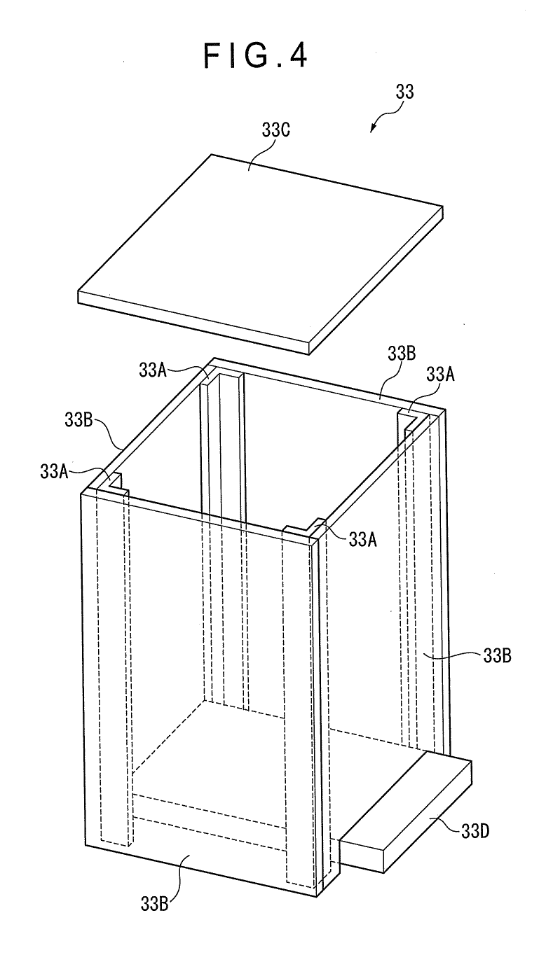

FIG. 5 is an illustration showing a structure of a spindle head body according to the exemplary embodiment.

FIGS. 6A to 6I are illustrations of examples of a structural member according to the exemplary embodiment.

FIG. 7 is an illustration of another example of the spindle head body.

### DESCRIPTION OF EMBODIMENT(S)

Exemplary embodiment(s) of the invention will be described below with reference to the accompanying drawings.

### Arrangement of Exemplary Embodiment

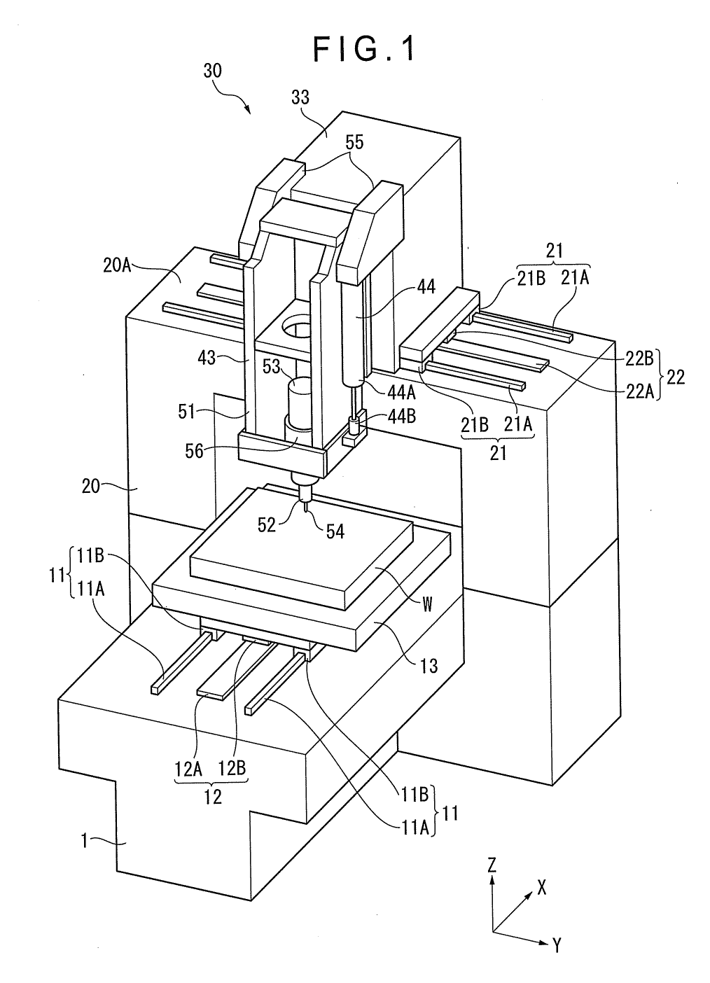

As shown in FIG. 1, a machine tool according to this exemplary embodiment includes: a base 1; a table 13 provided on the base 1 in a manner movable in X-axis direction via an X-axis guide mechanism 11 and an X-axis linear motor mechanism 12 (X-axis movement mechanism), the table 13 having a workpiece mount face on which a workpiece W is to be placed; a portal column 20 bridging over the table 13; and a spindle device 30 provided to a horizontal beam 20A of the portal column 20 in a manner movable in Y-axis direction via a Y-axis guide mechanism 21 and a Y-axis linear motor mechanism 22 (Y-axis movement mechanism).

The X-axis guide mechanism 11 includes guide rails 11A disposed on an upper face of the base 1 in parallel with each other along the X-axis direction, and slide members 11B disposed on a lower face of the table 13 in a manner slidable along the guide rails 11A.

The X-axis linear motor mechanism 12 is provided by a linear motor including a magnet 12A disposed on the upper face of the base 1 between and in parallel to the guide rails 11A, and a coil 12B attached to the lower face of the table 13 in a manner spaced apart from the magnet 12A.

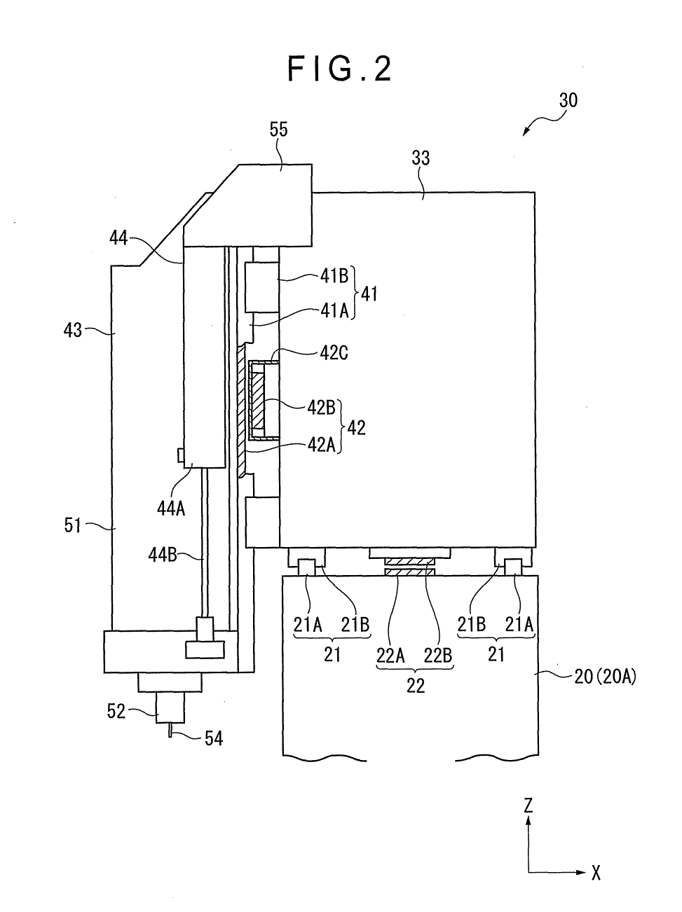

As shown in FIG. 2, the Y-axis guide mechanism 21 includes guide rails 21A disposed on an upper face of the horizontal beam 20A of the portal column 20 in parallel with each other along the Y-axis direction, and slide members 21B disposed on a lower face of the spindle device 30 in a manner slidable along the guide rails 21A.

The Y-axis linear motor mechanism 22 is provided by a linear motor including a magnet 22A disposed on the upper face of the horizontal beam 20A of the portal column 20 between and in parallel to the guide rails 21A, and a coil 22B attached to the lower face of the spindle device 30 in a manner spaced apart from the magnet 22A.

### Explanation of Spindle Device: See FIG. 2

As shown in FIG. 2, the spindle device 30 includes: a saddle 33 (spindle head support member) provided to the horizontal beam 20A of the portal column 20 in a manner movable in the Y-axis direction via the Y-axis guide mechanism 21 and the Y-axis linear motor mechanism 22; a spindle head 43 provided to the saddle 33 in a manner vertically movable via a Z-axis guide mechanism 41 (Z-axis movement mechanism) and a Z-axis linear motor mechanism 42 (vertical movement mechanism); and a balance cylinder 44 that generates a biasing force for supporting at least a part of the weight of the spindle head 43.

The Z-axis guide mechanism 41 includes guide rails 41A disposed on a back face of the spindle head 43 in parallel with each other along the Z-axis direction, and slide members 41B fixed on a front face of the saddle 33 for slidably guiding the guide rails 41A.

The Z-axis linear motor mechanism 42 is provided by a linear motor including a magnet 42A disposed on the back face of the spindle head 43 between and in parallel to the guide rails 41A, and a coil 42B attached to the front face of the saddle 33 in a manner spaced apart from the magnet 42A.

The coil 42B is covered with a heat shield 42C. The heat shield 42C is a box-shaped component made of a material such as aluminum and plastics.

As shown in FIG. 1, the spindle head 43 includes a spindle head body 51; a spindle 52 rotatably supported by the spindle head body 51 via a bearing mechanism 56; and a rotary drive source 53 for rotating the spindle 52. A tool 54 is detachably attached to the spindle 52. The rotary drive source 53 is provided by a motor.

The balance cylinder 44 includes a pair of balance cylinders 44 provided on both sides of the spindle head 43.

Each of the balance cylinders 44 includes: a cylinder body 44A of which an upper end is supported by the saddle 33 via a bracket 55; and a piston rod 44B having a piston of which an upper end is slidably housed in the cylinder body 44A and of which a lower end is connected to a lower end of the spindle head 43.

Air from an air source (not shown) is supplied via a pressure regulator or the like to a lower chamber of the cylinder body 44A partitioned by the piston. As a result, the balance cylinder 44 applies an upward biasing force to the spindle head 43, the biasing force being balanced with the weight of the spindle head 43.

In this exemplary embodiment, a movable-side member of a relative movement mechanism for relatively moving the table 13 and the spindle head 43 is provided by a combination of a plurality of types of structural members that are different in basic shape and are prepared in advance with a carbon fiber reinforced plastic (CFRP).

Among the components of the machine tool, the table 13, the saddle 33 and the spindle head body 51 are provided by the combination of the plurality of types of structural members different in shapes that are provided by a carbon fiber reinforced plastic (occasionally referred to as “CFRP” hereinafter). Next, a manufacturing method and structure of the above components will be described below.

### On Manufacturing Method of Table 13

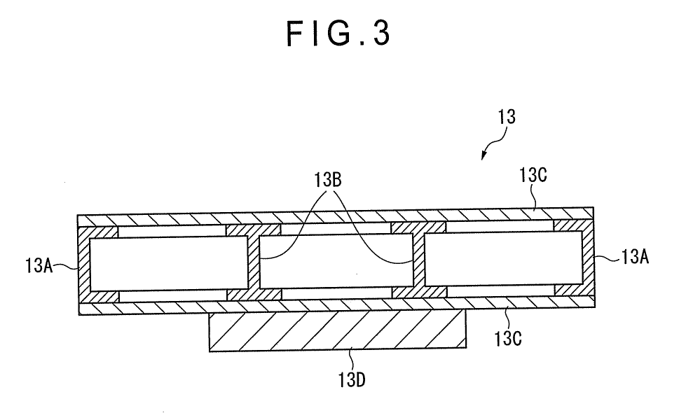

As shown in FIG. 3, the table 13 is provided by: CFRP structural members 13A of a C-shaped cross section that are disposed at four sides of the rectangular table 13; CFRP reinforcing structural members 13B of an I-shaped cross section interposed between front and rear ones of the structural members 13A and surrounded by the structural members 13A; rectangular CFRP face members 13C disposed at upper and lower faces of the structural members 13A and 13B; and a CFRP reinforcing face member 13D that is attached to the lower face of the face member 13C.

### On Manufacturing Method of Saddle 33

As shown in FIG. 3, the saddle 33 includes: CFRP structural members 33A of an L-shaped cross section disposed at four corners of the box-shaped saddle 33; rectangular CFRP side face members 33B attached between each pairs of the structural members 33A; a rectangular CFRP upper face member 33C attached to an upper face of the saddle 33; and a CFRP lower face member 33D attached to a lower face of the saddle 33.

### On Manufacturing Method of Spindle Head Body 51

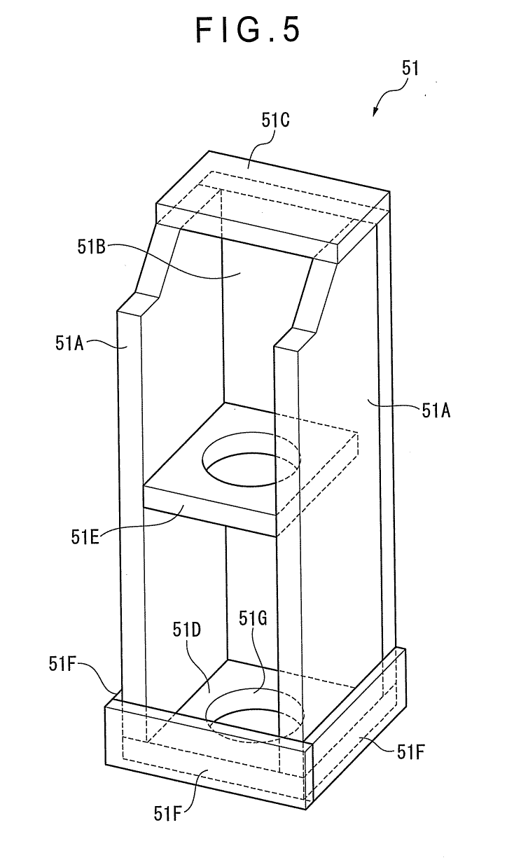

As shown in FIG. 5, the spindle head body 51 includes: a pair of CFRP side face members 51A that are disposed in parallel; a CFRP back face member 51B attached to back faces of the side face members 51A; a CFRP upper face member 51C and a CFRP lower face member 51D that are respectively attached to upper faces and bottom faces of the side face members 51A; a CFRP reinforcing face member 51E that is inserted between the side face members 51A; and CFRP reinforcing face members 51F that are attached to lower ends of the side face members 51A and the back face member 51B. In other words, the spindle head body 51 is provided in a vertically elongated box shape with the front face and a half of the upper face being opened. A hole 51G for receiving the spindle 52 is provided at the center of the lower face member 51D.

### Effect(s) and Advantage(s) of Exemplary Embodiment

In order to machine the workpiece W with the machine tool thus arranged, after the workpiece W is set on the table 13, the workpiece W is machined with the tool 54 while moving the table 13 in the X-axis direction, moving the saddle 33 in the Y-axis direction and moving the spindle head 43 in the Z-axis direction.

In this exemplary embodiment, since the movable-side members (i.e. the table 13, the saddle 33 and the spindle head body 51 of the spindle head 43) are made of the carbon fiber reinforced plastic, the weight of these members can be reduced. Thus, the movement speed of these members can be increased, whereby improvement in productivity can be expected.

In addition, since the table 13, the saddle 33, and the spindle head body 51 of the spindle head 43 are made of a combination of the plurality of types of structural members of different shapes that are made of the carbon fiber reinforced plastic, these components can be inexpensively manufactured.

Especially, since the spindle head body 51 is provided in a square tube of which at least three faces from among the front face, the both lateral faces and the back face (specifically, the both lateral faces and the back face) are enclosed with the CFRP structural members (the side face members 51A and the back face member 51B) and of which upper and lower faces are closed by the CFRP structural members (the upper face member 51C and the lower face member 51D), the spindle head body 51 can be provided in a less deformable structure. Thus, a high accuracy of the machine tool can be ensured.

In addition, since the CFRP reinforcing face member 51E is interposed at the middle part in the square tube, the rigidity of the spindle head body 51 can be enhanced by the presence of the reinforcing face member 51E, thereby further restraining the generation of deformations and distortions.

Incidentally, since the front face of the spindle head body 51 is opened, when the bearing mechanism 56 for supporting the spindle 52 and the rotary drive source 53 are installed in the spindle head body 51, the installation work can be facilitated.

In addition, since the vertical movement mechanism for vertically moving the spindle head 43 includes the Z-axis linear motor mechanism 42 including the magnet 42A that is provided to the spindle head 43 along the vertical movement direction of the spindle head 43 and the coil 42B provided to the saddle 33 in a manner facing the magnet 42A, the spindle head 43 can be smoothly and vertically moved with a high accuracy.

In addition, since the coil 42B of the Z-axis linear motor mechanism 42 is covered with the heat shield 42C, thermal deformation of the spindle head body 51 and the like due to the heat generated by the coil can be avoided. Thus, a high accuracy can be ensured.

### Modifications

It should be noted that the invention is not limited to the above-described embodiment, but includes modifications and improvements as long as an object of the invention can be achieved.

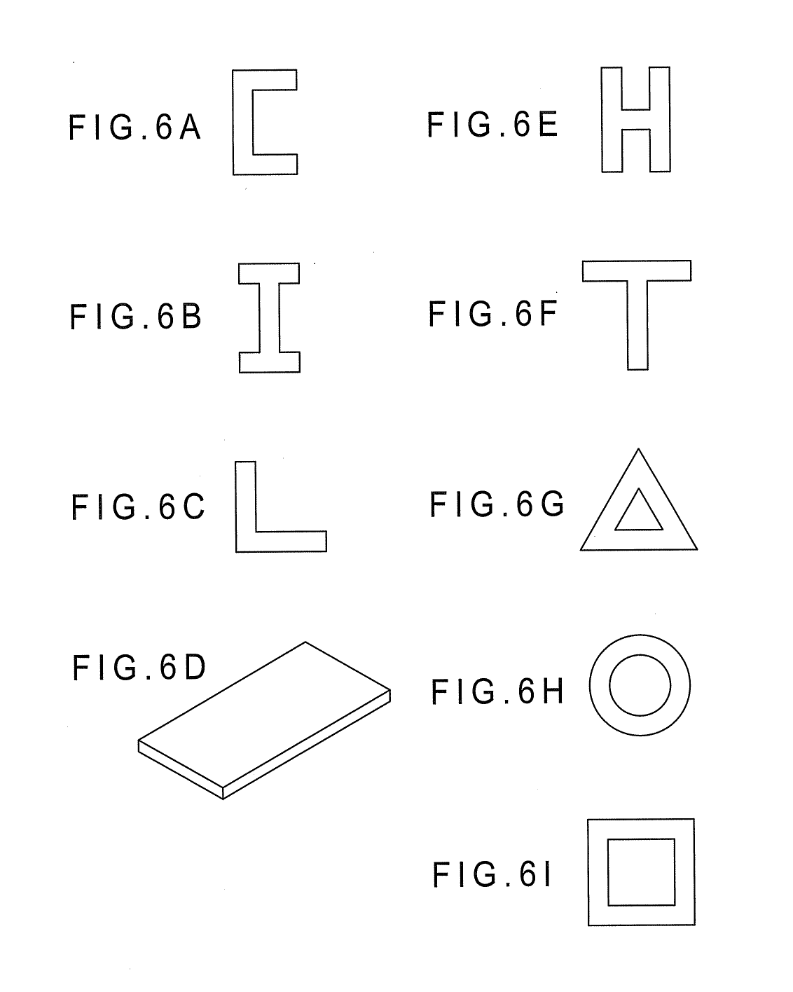

Though the structural members in the above exemplary embodiment include the component of a C-shaped cross section, the component of an I-shaped cross section, the component of an L-shaped cross section and the face member, such examples are not exhaustive. For instance, as shown in FIGS. 6A to 6D, in addition to the component of a C-shaped cross section, the component of I-shaped cross section, the component of an L-shaped cross section and the face member, structural members of H-shaped cross section, T-shaped cross section, triangular cross section, circular cross section and rectangular cross section as shown in FIG. 6E to 6I may be prepared in advance and necessary structural members may be selected from among these members for providing a machine component.

It should be noted that these structural members are manufactured according to a suitable molding process depending on a cross-sectional shape of the structural member. For instance, when a structural member of triangular, circular or rectangular cross section is to be manufactured, it is preferable that continuous carbon fibers impregnated with resin are wound around a core metal to form a tubular component.

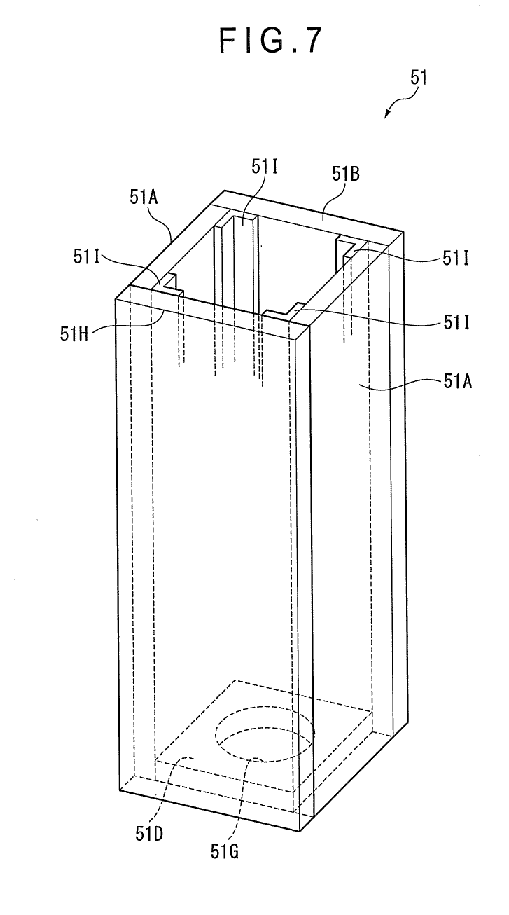

Though the spindle head body 51 is provided only by the face members (the side face members 51A, the back face member 51B, the upper face member 51C, the lower face member 51D and the reinforcing face members 51E and 51F) in the above exemplary embodiment, the spindle head body 51 may alternatively be formed in a structure as shown in FIG. 7. Specifically, as shown in FIG. 7, in addition to the side face members 51A and the back face member 51B, an additional CFRP structural member in a form of a front face member 51H may be combined to form a rectangular tube and CFRP structural members 51I of an L-shaped cross section may be bonded at four corners of the rectangular tube.

According to the above arrangement, since the front face of the spindle head body 51 is closed by the front face member 51H, in other words, since the spindle head body 51 is provided in a closed square tube, the rigidity of the spindle head body 51 can be further enhanced.

In the above exemplary embodiment, the movable-side member of the relative movement mechanism for relatively moving the table 13 and the tool 54 is provided by a combination of the plurality of types of structural members of different shapes that are prepared in advance with a carbon fiber reinforced plastic. However, such an arrangement is not exhaustive.

For instance, the horizontal beam 20A of the portal column 20 may be provided by a combination of a plurality of types of structural members of different shapes that are made of a carbon fiber reinforced plastic. Alternatively, all of the primary structural members of the machine tool including the base 1 may be provided by the combination of a plurality of types of structural members of different shapes that are made of a carbon fiber reinforced plastic.

Though the table 13 of the machine tool is movable in the X-axis direction and the spindle head 43 of the machine tool is movable in the Y-axis and Z-axis directions in the above exemplary embodiment, such an arrangement is not exhaustive. In other words, any structure is possible as long as the spindle head 43 is movable in at least one dimension (one axis direction).

Though the respective axis movement mechanisms of the above exemplary embodiment are provided by linear motor mechanisms (i.e. the X-axis linear motor mechanism 12, the Y-axis linear motor mechanism 22 and the Z-axis linear motor mechanism 42), the movement mechanism may be provided by a mechanism other than the linear motor mechanism. For instance, the axis movement mechanism may be provided by a feeding mechanism using a ball screw.

Though a motor is used as the rotary drive source 53 of the spindle 52 in the above exemplary embodiment, the rotary drive source may alternatively be an air turbine mechanism or the like.

Though the balance cylinder 44 is used in the above exemplary embodiment for generating a biasing force which is balanced with the weight of the spindle head 43, the biasing force may not necessarily be balanced with the weight of the spindle head 43. In other words, the balance cylinder 44 may generate a biasing force corresponding to at least a part of the weight of the spindle head 43.

What is claimed is:

1. A manufacturing method of a machine tool comprising: a table provided with a workpiece mount face on which a workpiece is placed; a spindle head; and a relative movement mechanism for moving the spindle head relative to the table, the spindle head comprising: a spindle head body; a spindle rotatably supported by the spindle head body via a bearing mechanism and being provided with a tool at an end thereof; and a rotary drive source for rotating the spindle, the method comprising:
preparing in advance a plurality of types of structural members of different shapes made of a carbon fiber reinforced plastic; and
combining the structural members of the different shapes to provide the spindle head body.

2. The manufacturing method of a machine tool according to claim 1, wherein
the structural members comprise a face member and a lower face member,
the spindle head body is provided in a rectangular tube shape of which at least three faces from among a front face, side faces and back face are surrounded by the face member and of which a lower face is closed by the lower face member, and
the spindle is rotatably supported by the lower face member via the bearing mechanism.

3. The manufacturing method of a machine tool according to claim 2, wherein
the structural members comprise a reinforcing face member, and
the reinforcing face member is disposed at a vertically middle of the rectangular tube substantially in parallel to the lower face member.

4. The manufacturing method of a machine tool according to claim 1, wherein
the structural members comprise at least one of components of a C-shaped cross section, an I-shaped cross section, an L-shaped cross section, an H-shaped cross section, a T-shaped cross section, a rectangular cross section, a triangular cross section and a circular cross section in addition to the face member.

5. The manufacturing method of a machine tool according to claim 1, wherein
the relative movement mechanism comprises: an X-axis movement mechanism for moving the table in an X-axis direction parallel to the workpiece mount face; a portal column bridging over the table; a saddle provided to a horizontal beam of the portal column in a manner movable in a Y-axis direction parallel to the workpiece mount face of the table and orthogonal to the X-axis direction, the saddle supporting the spindle head; a Y-axis movement mechanism for moving the saddle in the Y-axis direction; and a Z-axis movement mechanism for vertically moving the spindle head relative to the saddle in a Z-axis direction orthogonal to the X-axis direction and the Y-axis direction, and
the table and the saddle are provided by combining the structural members of the different shapes.

6. A machine tool manufactured by the manufacturing method of a machine tool according to claim 1.
